(19) United States
(12) Patent Application Publication
(10) Pub. No.: US 2014/0272817 A1
(43) Pub. Date: Sep. 18, 2014

(54) SYSTEM AND METHOD FOR ACTIVE GUIDED ASSISTANCE

(71) Applicant: Provictus, Inc., Foster City, CA (US)

(72) Inventors: David H. PARK, Foster City, CA (US); Thomas W. FURPHY, Sammamish, WA (US)

(21) Appl. No.: 14/217,141

(22) Filed: Mar. 17, 2014

Related U.S. Application Data
(60) Provisional application No. 61/801,327, filed on Mar. 15, 2013.

(51) Int. Cl. G09B 5/02

(52) U.S. Cl. CPC G09B 5/02
USPC 434/127

(57) ABSTRACT

Disclosed here is a technology for providing active guided assistance in culinary execution to consumers in real-time. The guided assistance can take the form of a platform system implemented on an electronic device that provides recipes, recipe details (e.g., timing, techniques, cooking tools, ingredients, steps), and one or more guidance tools including any one of a meal plan, a shopping list, a nutrition tracker (or “health tracker”), a taste profile, or an allergen/medical filter. The guided assistance dynamically adapts its content in response to a user's understanding and progress with respect to each step in executing a recipe. The content includes integrated culinary information collected from various sources of information, including a system-generated database or third-party systems.

### TECHNICAL FIELD

The disclosure relates to tools for providing instructions, and more specifically to an active guided assistance platform system.

### BACKGROUND

While innovations arise in many areas of everyday life, little has changed with regards to recipes and culinary instruction. Current tools for recipe delivery are typically naïve; they present recipes generally in a flat approach that provides bare-bone publications of information (e.g., printed materials, instructional videos, static webpages, or semantic searches), lacking in-experience, real-time assistance to properly meet the realities of day-to-day cooking faced by the ordinary consumer. Further, delivery of the recipes through these publications provide no insights to the cooking experience, such as food knowledge, nutrition, wellness education, meal planning, a better execution of cooking at home, or how to save money on meals. Ordinary consumers have no way take control or interact with various sources across different avenues that offer these insights, such as the workplace, supermarkets, medical providers, family/friends, the gym, and/or food companies.

### BRIEF DESCRIPTION OF THE DRAWINGS

FIG. 1 is a block diagram illustrating an environment in which the disclosed technology can operate in various embodiments.

FIG. 2 is a block diagram illustrating a system to create integrated culinary content for a guided assistance, according to various embodiments.

FIG. 3A-3B are example recipe selection graphical user interfaces that allow a user to select a recipe to start cooking, according to various embodiments.

FIG. 4 is an example recipe detail graphical user interface, according to various embodiments.

FIG. 5 is an example ingredient graphical user interface, according to various embodiments.

FIG. 6 is an example guided assistance graphical user interface, according to various embodiments.

FIG. 7 is an example videoconference graphical user interface that allows the user to communicate with another individual while cooking, according to various embodiments.

FIGS. 8-9 are example alert graphical user interfaces that can be generated during a cooking session, according to various embodiments.

FIG. 10 is an example user profile graphical user interface that allows a user to customize the profile, according to various embodiments.

FIG. 11 is an example health tracker graphical user interface that allows a user to track health associated with the user's cooking history, according to various embodiments.

FIG. 12 is an example food diary graphical user interface that allows a user to keep a history of the user's food, according to various embodiments.

FIG. 13 is a sequence diagram illustrating a process for providing culinary content based on user inputs using a content delivery device, according to various embodiments.

FIG. 14 is a flow diagram of a process for generating integrated culinary content, according to various embodiments.

FIG. 15 is a block diagram illustrating components of an apparatus that may perform various operations described by the disclosed technology.

### DETAILED DESCRIPTION

Disclosed here is a technology for providing guided assistance in culinary execution to consumers in real-time (“the technology”). The guided assistance can provide recipes, cooking instructions, and one or more guidance tools including any one of a meal plan, a shopping list, a nutrition tracker (or “health tracker”), a taste profile, or an allergen/medical filter. The guided assistance can take the form of a content delivery platform that offers a collaborative underlying infrastructure connecting a consumer with various sources of information. As used herein, the term “platform” refers to any computing system comprising of hardware, software, and/or any combination thereof. In one aspect, the platform is implemented in an electronic device (e.g., operating system). In another aspect, the platform is implemented as a downloaded application that resides on a personal computing device, such as a tablet or a laptop, for example, an installed mobile application downloaded from an app store or a cloud service. The platform combines the consumer's preferences with information from the various sources to deliver integrated culinary content to the consumer in real-time. For example, the platform provides a consumer not only step-by-step cooking instructions of a recipe, but also a health tracker that analyzes the ingredients from the recipe and presents nutritional information. Hence, a consumer is relieved of the inconvenience of having too little information or too much irrelevant information, and is able to obtain a tailored cooking experience.

The consumer discussed herein can be any ordinary individual who wishes to search for recipes, learn how to cook, and/or gain insights into the culinary experience, such as an understanding of food and nutrition and how to live a healthier life. The sources discussed herein can include any suppliers, providers, and/or retailers of information associated with food, cooking, diet, nutrition, or medical and lifestyle expertise, among others. The sources of information can be sources external to the platform (e.g., third-party systems) or sources internal to the platform (e.g., databases of stored information of the platform). Through the platform a particular source is able to provide the consumer integrated cooking education, not just flat information; that is, data from the particular source is combined with data from other sources and delivered to the consumer in an integrated, intelligent format. For example, the platform presents particular produce items that are on sale at a food supplier, where the particular produce items are ingredients of a recipe extracted from a retailer's cookbook. Further, each particular source is able to obtain from the consumer feedback associated with the presented content in real-time via the platform. Hence, the platform opens an avenue for different sources to provide relevant information to consumers, and at the same time, assist the consumers to enjoy a better cooking experience.

The platform can be in communication with one or more electronic kitchen appliances to allow control of the appliances via the platform. As used herein, an “electronic kitchen appliance” refers to any electronic cooking device capable of carrying out a cooking-related tasks via controls by a remote device (e.g., the platform) over a communication network (e.g., Bluetooth, Internet, WAN, LAN, etc.). A consumer or an operator of the platform can use the platform to manage settings and monitor status of the kitchen appliance during a cooking process. An example kitchen appliance is a web-enabled oven that allows a consumer to control, via the platform, various oven features, such as the temperature or the start/stop time. In such example, the consumer can use the platform to configure the oven's settings to cook according to information extracted from a recipe, such as cook at 300 degrees for 40 minutes and turn off automatically at the end of 40 minutes. Another example is a digital scale connected to the platform that allows for more precise measurement of ingredients for better controlled cooking.

In an illustrative use case, a consumer accesses the guided assistance by powering on a device containing the platform (“platform device”) to start a cooking process. The platform device includes a guided assistance that is implemented using one or more graphical user interfaces (GUI) to provide the consumer integrated culinary content for executing in the cooking process. The integrated culinary content includes information extracted from various sources. The platform device combines the information from the various sources to provide the consumer a comprehensive knowledge base to assist in the cooking process. The knowledge base can include recipes, instructional videos, nutritional information, health and/or fitness calculators, serving suggestions, event planning guides, relevant advertisements, among others. For example, information from the knowledge base includes grocery items and produce on sale at various local grocery stores, dietary plans, and cooking instructions for various recipes.

In the use case, the sources include an Encyclopedia of Food, which contains a comprehensive set of ingredients, food types, and recipes, a Nutrition Database, which contains nutritional information about food ingredients, a Techniques Database, which contains instructional materials on cooking (e.g., videos, still images, etc.), and a Tools Database, which contains kitchen tools that can be used during the cooking process. Other types of sources that provide culinary-related information can be utilized with the disclosed technology. The consumer can adjust what sources of information are utilized by the platform in delivering the culinary content. An admin of the platform can also adjust what sources of information are utilized.

The platform device facilitates analyzing semantics, ontology, and metadata available from the sources to generate the integrated culinary content for the consumer. The culinary content can be tailored according to the consumer's needs (e.g., allergies), cooking preferences (e.g., low carb meal), and/or any other requirements. The integrated culinary content, unlike flat content of the traditional recipe delivery approach, includes analyzed data that offer the consumer culinary insights at every step of the cooking process, from meal preparation through meal completion.

The consumer can start the cooking process by submitting inputs indicating what he wants to cook. For example, the consumer submits all ingredients he currently has in his refrigerator to request recipe ideas from the platform. The consumer can also start by indicating to the platform how he wants to cook: cook with one or more other individuals or cook by himself. The one or more individuals can be, for example, a family member, a friend, or a chef. If the consumer selects to cook by himself, he can proceed to select a recipe right away. If the consumer selects to cook with one or more individuals, the platform device initiates a connection with the individual. For example, the platform initiates a videoconference with the one or more individuals. The platform device can request contact information of those individuals from the consumer. In some instances, the platform device prompts the consumer to select individuals from an address book stored on the platform device. The address book can be a personal address book of the consumer, or it can be a global address book of a service server associated with the platform device (e.g., names of all consumers of a culinary content delivery service organization operating the the platform device).

The consumer next submits one or more via the platform device using, for example, an input device associated with the platform device (e.g., physical keyboard, an on-screen keyboard, voice command, etc.), to find a recipe. The inputs can include one or more cooking related requirements or personal preferences. For example, the consumer submits a “peanut allergy” and a “whole grain” to find recipes with these restrictions. In another example, the inputs include “India” to indicate the consumer's preference for a recipe from the country India. The inputs can include a selection from the consumer's favorite recipes stored on the platform device. Other stored recipes can be selected at this step, such as recipes of a family member.

In response to the consumer's submitted inputs, the platform device retrieves relevant data from sources stored in its database to generate the guided assistance. In some instances, the platform device communicates with third-party sources to extract relevant information associated with the consumer's submitted inputs, and generates the guided assistance. The guided assistance can include a list of recipes, a list of ingredients that can be selected for various purposes (e.g., to create a shopping list, to view nutritional information, etc.), or advertising content associated with the relevant information. For example, the guided assistance includes a list of whole-grain based recipes without peanuts and/or peanut alternatives, nutritional information for the recipes, and kitchenware needed for the recipes. In another example, where the consumer submits requirements for “low-carb diet” and “weight loss for women,” the platform analyzes the sources to extract and present a weight loss meal plan with various low-carb recipes. In yet another example, where the consumer submits “meals from India,” the platform generates a list of recipes with Indian spices and/or from India and an advertisement for a nearby Indian food market.

The consumer next selects a particular recipe from the various recipes presented by the platform device. In some instances, the platform device presents a recipe roulette that allows the consumer to select a recipe. In some instances, the platform device presents the recipes in a list for selection. In response to a recipe selection, the platform device presents a sequence of steps for the recipe. In particular, the platform displays the turns and evolution at each step as the consumer makes changes in the real world, for example, by moving digital content, such as a video footage (e.g., placing of egg in pot of water with wooden spoon), along in sync to match and guide the consumer in the real world.

The platform device provides the consumer the ability to control the sequence of cooking content. For example, while viewing the content, the consumer can stop, start, go into more details, go backwards, or go forward in the content to review a particular step more carefully. For example, the consumer selects to view the description about stewing tomatoes at step 3, where the description can include, for example, types of tomatoes, how to cut tomatoes, how to de-skin tomatoes, where to buy organic tomatoes, among others, to help the consumer gain a better understanding of that step. The consumer can further interact with the content by recording completion of each step. For example, at the end of boiling water for 15 minutes, the consumer submits a check-mark for that step to indicate completion. In another example, the consumer touches an item or a step to mark completion by interacting with a user interface on a touch-screen display (e.g., touches a pot with boiling water and it disappears). The platform device can generate safety alerts associated with the content. For example, where the consumer forgets to indicate completion for the boiling water step, the platform device generates a pop-up alert to notify the consumer that the pot has been boiling for 20 minutes, where the step instructs only 15 minutes.

The platform device can present ingredient and kitchenware information along with the content at each step of the cooking process. The information can be retrieved from a database of the platform. The information can be displayed as image format or text. In one example, still images of an onion, olive oil, and a pan are displayed along with “Step 4—Sauté Onions.” In another example, ingredients for an entire recipe are displayed as a list next to the content. Following along the content, the consumer is able to comfortably, and confidently, learn the skills to cooking according to his needs.

The platform device can provide the consumer a health tracker for tracking information associated with the consumer's health (or “health content”). The health tracker includes a visual food diary of meals completed by the consumer. The visual food diary can include, for example, types of foods and/or ingredients associated with those meals. The health tracker is generated based on the consumer's profile and/or interactions with the device. The consumer's profile can be manually created by the consumer or can be submitted via a wearable electronic device in communication with the platform. The consumer's profile include, for example, the consumer's age, gender, user preference inferred from recipe selections, or other personal information submitted by the consumer (e.g., a Mom, a novice chef, peanut allergy, location, etc.). The interactions with the device include, for example, a history of recipes completed by the consumer, requests for certain information by the consumer, submission of cooking requirements, among other interactions. The platform device analyzes the interactions to extract ingredient and nutrition information associated with the consumer, where such information has been cross-analyzed with recipes selected by the consumer to cook over a period of time. In some instances, the platform device learns the consumer's interactions with the device, infers certain profile characteristics, and stores such profile characteristics for use in the guided assistance.

The platform device can present to the consumer contextually relevant advertising content in association to the cooking process and/or recipe. The advertising content can be generated based on the consumer's interactions with the platform and/or the consumer's profile. For example, the platform device presents a supermarket's coupon for almond butter to a consumer who has submitted a peanut allergy dietary restriction (i.e., requirement). In another example, the platform device presents a list of cooking tools being sold by several retailers, where the tools are necessary for a recipe selected by the consumer for cooking. In another example, the platform device presents a list of on-sale items at a local grocery store, where the items have been cross-checked with the consumer's selected recipe to cook for the day, and the local grocery store is identified based on the consumer's address. In yet another example, the platform presents a video program associated with parent-child bonding activities in the kitchen based on the consumer's “mom” profile.

Other aspects and advantages of the disclosed technology will become apparent from the following description in combination with the accompanying FIGS. 1-16, illustrating, by way of example, the principles of the claimed technology. In this description, references to “an embodiment”, “one embodiment” or the like, mean that the particular feature, function, structure or characteristic being described is included in at least one embodiment of the technique introduced here. Occurrences of such phrases in this specification do not necessarily all refer to the same embodiment. On the other hand, the embodiments referred to also are not necessarily mutually exclusive.

FIG. Error! Reference source not found. is a block diagram illustrating an environment Error! Reference source not found.00 in which the disclosed technology can operate in various embodiments. A culinary content delivery system 110 (hereinafter, “content delivery system”) provides a user 102 cullinary information, such as the integrated culinary content mentioned above, based on user data 106 input by the user Error! Reference source not found.02 and source data 108 obtained from sources 120. The content delivery system 110 can be utilized to implement the content delivery platform discussed above. The user 102 can be a customer, a consumer, or any individual utilizing the content generated by the content delivery system 110. The user 102 communicates with the content delivery system 110 by using a computing device 104, such as a desktop computer, a laptop, a smartphone, or any other electronic device capable of communications over a communication network. Using the computing device 104, the user 102 can submit the user data 106 to the content delivery system 110.

The content delivery system 110, connected to a communication network (e.g., the Internet), maintains an infrastructure that facilitates and maintains a guided assistance 130 for assisting the user 102 in a cooking process. In various embodiments, the content delivery system 110, in full or in part, can reside on a mobile device 104 (e.g., in a mobile application, in an operating system, etc.), on a server (e.g., a server in the cloud maintained by a culinary service organization), or can be distributed between the mobile device 104 and the server. In some embodiments, a computer system of a culinary service organization can distribute the guided assistance 130 via an application (hereinafter, “app”). The app can be a native app (e.g., installed on the mobile device 104 by a device or operating system manufacturer), an app that is downloaded by a user of the mobile device 104 from an app store or directly from an app publisher, or an app that is operating via a cloud service.

The content delivery system Error! Reference source not found.10 analyzes the user data 106 and the source data 108 to generate the guided assistance 130. The user data 106 includes input information associated with needs, preferences, and/or requirements of the user 102. For example, the user data 106 includes a request from the user 102 to start a videoconference with another individual to start a cooking session. In another example, the user data 106 includes personal profile information about the user 102, such as age, gender, and geographical location (e.g., address, zip code, etc.). In yet another example, the user data 106 includes food allergies and taste preferences

The source data 108 includes a comprehensive knowledge base of information from the sources 120. The sources 120 can include a content delivery database 124 of the content delivery system 110. In one example, the content delivery database 124 stores data received from an administrator submitting cooking related data to the content delivery system 110, where the stored data becomes information that can be used by the system 110 in facilitating and maintaining the guided assistance 130. In another example, the content delivery database 124 stores data generated by the delivery system 110 based on an analysis of various other data received by the system 110. In some embodiments, the sources 120 can be one or more third-party systems 122 in communication with the content delivery system 110. The sources 120 provide information associated with food, cooking, diet, nutrition, or medical and lifestyle expertise, among others. The information can originate from (e.g., authored, written, etc.) a food broker, a food manufacturer, a restaurant equipment supplier, a paper goods and linens supplier, an exercise equipment provider, a grocery store, a health center, a fitness store, a culinary institute, a medical expertise store, a nutritionist, a farmer, a chef, a cookbook, a researcher, an expert, an encyclopedia of food, a database of cooking techniques, a database of nutritional information, a database of cookware (or kitchen tools), a database of written culinary materials, among others.

The content delivery system 110 analyzes the source data 108 to filter out certain source data from the various sources that would serve the needs of the user 102. In some embodiments, the content delivery system 110 combines the data from the various sources and presents to the user 102 integrated content in the form of the guided assistance 130. The guided assistance 130 can be presented, for example, using one or more graphical user interfaces (GUIs) on a display of the computing device 104. The guided assistance 130 assists the user 102 in a cooking process, where such assistance is tailored to the needs, preferences, and/or requirements of the user 102, as defined by the user data 106. The integrated content of the guided assistance 130 can include a number of recipes, and more specifically, timing of each recipe (e.g., how long it takes for each step and/or the whole cooking process), tools needed for each recipe (e.g., pot, long wooden spoon, etc.), cooking techniques associated with each recipe (e.g., how to peel a carrot before cooking), ingredients for each recipe, actions of each recipe (e.g., step-by-step instructions) and various guidance tools tailored to the user's needs (e.g., meal planning, health tracking, shopping list, taste profiling, or allergen/medical filter). For example, the content delivery system 110 receives user data that the user is looking for a vegetarian Indian recipe, determines a list of appropriate recipes based on that input information, analyzes the source data 108 to filter out appropriate information and to generate relevant integrated content, and presents the integrated content in the guided assistance 130 to the user 102.

In some embodiments, the user 102 may want to view and/or modify specific items presented by the guided assistance 130. Via the computing device 104, the user 102 submits new user data 106 to interact with the guided assistance 130, for example, to request changes to the presented integrated content. The content delivery system 110, in response to the newly submitted user data 106, generates a new version of the guided assistance 130 to include modified integrated content. In another example, the user 102 submits a request to find a new recipe (e.g., low carb). In such example, the content delivery system 110 analyzes the source data 108 to identify appropriate content based on the request and generates a new guided assistance 130.

In various embodiments, the integrated content of the guided assistance 130 created by the content delivery system 110 depends on the sources 120 (e.g., database 124 or third-party systems 122), the type of information (i.e., source data 108) provided by those sources (e.g., nutritional facts, recipes, diet regimes, etc.), and interactions from the user 102 (e.g., submission of user data 106 to select or deselect a source). The creation of content for the guided assistance 130 is described in further detail with reference to FIGS. 2-14.

FIG. Error! Reference source not found. is a block diagram illustrating a system Error! Reference source not found.00 to create integrated content for a guided assistance presented to a user, according to various embodiments. In various embodiments, the system Error! Reference source not found.00 may be implemented in the environment Error! Reference source not found.00 of FIG. Error! Reference source not found. The system 200 can be the content delivery system 110 of FIG. 1. As discussed above, the user is any individual receiving content from the system to assist in the process of cooking. The system Error! Reference source not found.00 can be used to create integrated content using various information retreived from various sources (e.g., databases of third-party services or databases of the system 200), and to generate a guided assistance with the integrated content for assisting a user of the system 200 in the cooking process, from meal preparation to meal completion. The integrated content may be stored in a computer readable medium according to any suitable storage mechanisms, such as those well known in database storage techniques. The guided assistance that contains the content can be generated by a guidance component 208.

The system Error! Reference source not found.00 includes a data gathering component 202 that gathers user input, culinary data, and culinary-related advertising data (e.g., types of kitchen tools, cooking classes, produce sales, etc.). In various embodiments, the data gathering component 202 gathers the user input in the form of culinary features, keywords or phrases submitted via an input device by the user, where the features, keywords or phrases are describing or associated with the user's preferences, needs, or requirements. For example, the user submits what ingredients the user has available (e.g., items leftover in the pantry) and a request for suggested recipes utilizing those ingredients. In some embodiments, the user input can include a request to start a videoconference with one or more individuals, for example, to start cooking with the user's friend. In such example, the data gathering component 202 receives such data and starts gathering data associated with that friend and information associated with a cooking session for a videoconference. The data gathering component 202 gathers the user input information for a data analysis component 204 to analyze in setting up the guided assistance.

The data gathering component 202 also gathers the culinary data and the advertising data (“ad data”) along with the user input. The culinary data can include, for example, instructions, descriptions, discussions, videos, or still images associated with or relevant to cooking, such as recipes, images of food and/or produce items, nutrition content, instructional videos, nutrition articles, allergen information, diets, lifestyle information, etc. The advertising data can include, for example, promotional content or targeting criteria (e.g., a particular advertiser's targeting campaign) provided by retailers, providers, or suppliers that can be useful to the user, such as an ongoing sale at a nearby retailer, produce items offered by a local grocery store, cookware that would be of interest to the user, fitness class, nutritional program, etc. In some embodiments, the data gathering component 202 gathers the ad data in the form of database information transmitted over a network. The network can include WiFi, Bluetooth, WLAN, LAN, etc.

The sources from which the data gathering component 202 obtains the culinary data can include third-party sources, such as websites, blogs, journals, documents, or magazines, books, databases, among others. The sources can also be internal databases of a culinary content delivery organization that utilizes the content delivery system to generate the guided assistance (e.g., guided assistance 130 of FIG. 1). In some embodiments, a user, too, can provide the culinary data and advertising data to the data gathering component 202. The user can be the user utilizing the guided assistance generated by the system 200, or another user associated with the system 200. The data gathering component 202 combines the information from the various sources to obtain a comprehensive knowledge base that can be used by the system 200 to provide user-tailored information for various culinary executions.

The data analysis component 204 cross-analyzes the user input, the culinary data, and the advertising data to extract information that is relevant to or associated with cooking and/or culinary arts related to the user's needs, preferences, and/or requirements, as defined by the user input. For example, from the information extracted, the data analysis component 204 can identify recipes, ingredients, nutritional values, and diet plans fitting the information associated with from the user input. The data analysis component 204 analyzes the extracted information from the user input to identify the keywords, phrases, or features indicative of the user's needs, requirements, or preferences in a recipe that the user wants to start cooking.

In one example, the data analysis component 204 identifies the word “India” and “vegetarian” from the user input. Based on the extracted information from the user input, the data analysis component 204 analyzes the culinary data and ad data to identify and extract relevant information (e.g., Indian recipes, advertisements related to local India grocery stores, traditional cookware used in Indian cooking, etc.). The data analysis component 204 analyzes the data based on semantics, ontology, and metadata available from the sources of the culinary data and the ad data. In some embodiments, the data analysis component 204 can be implemented using a rule-based system, a clustering engine, or various other self-learning techniques that can classify, group, categorize or associate different data based on a certain criteria.

From the culinary data, the data analysis component 204 identifies 10 recipes with the keyword India and vegetarian from sources W and X, and further identifies ingredients and nutritional value information from those 10 recipes by cross-analyzing the recipe information with information from sources Y and Z. Sources W and X can be, for example, an encyclopedia of foods around the world stored in a database of the system 200, or a cookbook or a magazine article from third-party sources in communication with the system 200. Sources Y and Z can be, for example, a public health organization's nutrition database, a research paper, or a website. The data analysis component 204 passes on this analyzed data to the guidance component for generating a guided assistance having the analyzed data as content. For example, the analyzed data is used to generate timing for a recipe (e.g., the meal takes 60 minutes to prepare and cook), tools for the recipe (e.g., cast iron pan which can be bought at Store X), techniques for the recipe, a list of ingredients for the recipe, and actions to be taken for the recipe (e.g., step-by-step instructions).

In some embodiments, the data analysis component Error! Reference source not found.04 also analyzes metadata associated with the information extracted from the culinary data and ad data to obtain any information, including keywords that may be used to identify the particular needs of the user, as defined by the user input. In some embodiments, the data analysis component 204 analyzes the data to extract information based on keywords being semantically same.

Further, in various embodiments, the data analysis component 204 may perform additional analysis before passing the analyzed information to the guidance component 208. The additional analysis is performed to generate content for one or more guidance tools that can be implemented by the guidance component 208. In various embodiments, the one or more guidance tools include any one of a meal plan, a shopping list, a nutrition tracker (or “health tracker”), a taste profile, or an allergen/medical filter. For example, the data analysis component 204 may analyze the nutrition details of a particular meal to break down all nutritional intakes based on that recipe to present in a health tracker for the user (e.g., calories, fat, protein, vitamins). In another example, the data analysis component 204 may analyze the ingredients of a recipe with a grocery store's advertised weekly specials to assist in a shopping list for the user. In another example, the data analysis component 204 may cross-analyze the ingredients in the recipes identified with a user's allergen list to determine the recipes that would pose a health risk to the user. In such example, recipes that contain those allergens would be eliminated from a recipe result list for the user.

The recipe component 204 generates a list of recipes that correspond to the user input based on the analyzed information associated with cooking instructions from the data analysis component. For each of the recipe in the list of recipes, the recipe component 206 organizes and generates integrated culinary content for display to the user of the cooking process of each recipe. In some embodiments, the cooking content is organized with each step of the cooking process being, for example, in a different frame, representing a step, of a series of frames that can be selected to expand cooking details.

The guidance component 208 receives the analyzed information from the data analysis component 204 and the organized recipe information from the recipe component 206 as integrated content to generate a guided assistance for the user to start cooking. In various embodiments, the guidance component 208 may generate one or more GUIs to present the guided assistance to the user. The guidance component 208 generates the one or more GUIs based on the analyzed information and organized recipe information received from the data analysis component 204 and recipe component 206. The one or more GUIs can include, for example, timing of a recipe, tools, techniques, ingredients, and actions associated with each recipe. Further, advertising content can be integrated throughout the content presented by the GUIs. For example, tools are presented to help a user understand the cookware needed for a recipe, where the user can select a particular tool to view one or more retailers selling the selected tool.

Other content presented by the GUIs can include, for example, a health tracker, a videoconference session, a meal planner, a shopping list, a taste profile, and/or an allergen/medical filter. The meal planner, for example, can assist the user to create, for example, meals for the week by organizing recipes presented by the guidance component 208. The shopping list can assist the user to generate a list of produce and/or food items that need to be bought for one or more recipes. In some embodiments, the guidance component 208 automatically generates the shopping list based on the recipe(s) selected by the user. The taste profile can assist the user to select a particular recipe based on the user's taste. For example, salty, sour, bitter, or sweet preferences of a particular user are cross-referenced with the recipes to make recommendations to the user. The allergen/medical filter can assist the user, for example, to filter out the recipes based on the user's medical needs (e.g. high cholesterol, food allergies, etc.). As such, the recipe component 206 will not include recipes that do not correspond to the user (e.g., medical needs, taste preference, etc.)

In some embodiments, the guidance component 208 dynamically changes the integrated culinary content displayed for the user based on interactions from the user with the presented guided assistance content. For example, the guided component 208 facilitates the presentation of the information based on the user's request to stop, start, go into details, go backwards, or go forward in the frame-to-frame content to review a particular step more carefully while cooking. In another example, the user selects to view a kitchen tool needed for a cooking step of a recipe. In such example, the guidance component 208 retrieves relevant data to display to the user, including, for example, technical aspects of the tool and advertisements associated with the tool. For example, the guidance component 208 retrieves and displays advertisements from two different retailers that sell a cast iron pan needed in the step, in addition to information about the different types of cast iron pans and maintenance of cast iron pans.

In various embodiments, the guidance component 208 can track the user's interactions, or user input, to infer certain cooking-related information about the user. Accordingly, the guidance component may track the user's interactions with the one or more GUIs and determine whether certain content or analysis presented can be improved to better match with what the use's preferences. For example, such content or analysis inferred by user's interactions may be combined with ad data to deliver better advertisements. In another example, the guidance component 208 may use the content or analysis to update the user's profile.

FIG. 3A-3B illustrate example graphical user interfaces that allow a user to select a recipe to start cooking. It should be noted, however, that the user may input the recipe selection in various other ways, including free text, using other types of graphical user interfaces. Referring to FIG. 3A, the graphical user interface (GUI) for the receipt selection 300 includes a recipe selection input as part of a wheel of recipes, any one of which can be selected and/or viewed by spinning the wheel. In various embodiments, graphical user interface (GUI) for selecting a recipe can be implemented in a system such as system Error! Reference source not found.00 of FIG. Error! Reference source not found.

The user can submit various types of inputs associated with the recipe selection using the wheel. The various types of inputs can include a cooking partner selection, a mood, a timing, an ethnic food type, a chef (e.g., recipe(s) associated with a celebrity chef), ingredients, among others. For example, the user selects an individual named “Kay” with whom the user wishes to start cooking, a “romantic” mood for the type of meal, and a “1 hr” timing for the meal, with no specific indication whether the recipe comes from any specific chef. In such example, a series of recipes are presented that match the input selections, such as “Roasted Lamb Sirloin,” Recipe X, and Recipe Y, all of which have been analyzed to have the characteristics of being a romantic meal and can be completed in 1 hour. From the user's input, the platform system generates the appropriate recipes and associated content to display for the user (e.g., timing, tools, techniques, ingredients, or actions).

In the illustrated embodiment, the instructions for each recipe are presented in a metadata enabled, mixed-media format. Under such format, the user has access to various media, for example, still images, audio, and/or videos interacting to assist the user in the cooking process. For example, in the step to boil an egg for a soft-boiled egg recipe, the user is presented with an image of the inside of a soft-boiled egg and a video of water boiling at the appropriate temperature.

Referring to FIG. 3B, the GUI for the recipe selection 302 facilitates a recipe selection input via text entry and buttons. Similar to the GUI 300, the user is able to submit various inputs associated with the receipt selection. In the illustrated embodiment, the user can select certain ingredients the user desires to have in the recipe (e.g., “Items I have in my refrigerator”). The GUI 302 allows the user to go through the recipes by a “flip” action that turns the pages of recipes, from one recipe selection to another recipe selection. The various input selections may be deleted if the user desires to start over with a fresh new set of recipes.

FIG. 4 is an example recipe graphical user interface (GUI) 400 for viewing details associated with a selected recipe, according to various embodiments. In the illustrated embodiment, the recipe GUI 400 presents a timing of the recipe (e.g., 1 hour) for making the recipe, the tools needed for the recipe, the techniques for the recipe (e.g., pan fry lamb), the list of ingredients for the recipe, and the actions needed for the recipe (e.g., step-by-step instructions). In various embodiments, the user can browse through each recipe and view the integrated content associated with each recipe (e.g., timing, tools, techniques, list of ingredients, and actions) before actually beginning the cooking process. For example, the user, through the platform, can view the techniques needed for the recipe, and practice each technique, before beginning the cooking process.

Referring back to the content presented by the GUI 400, the user can view content that includes each step of the cooking process (e.g., steps 1-4). Further, at each step, the GUI 400 presents a timing that indicates how long each step would take. For example, the user presses play to play the content and each step of the content is displayed only for the appropriate passage of time for that step, such that the user is able to follow the instructions in real time. At any step of the cooking process, the user can select to view details of the step. For example, the user can select to learn about a technique associated with a step (e.g., how to pan fry lamb).

The GUI 400 also presents a list of ingredients extracted from the recipe. In some embodiments, the user can select to view details of a specific ingredient, as illustrated in the ingredient GUI 500 of FIG. 5. The ingredient GUI 500 can present to the user information associated with the specific food ingredient, including for example, history, regional information, nutritional information, and/or other similar ingredients (e.g., types of mushrooms). Referring back to the recipe GUI 400, in some embodiments, the user can create a shopping list based on the list of ingredients by interacting with the GUI 400, for example, by clicking on the button “Create Shopping List.” Other options are available to allow the user to interact with the recipe GUI 400, including to view what other recipes fit with the selected recipe (e.g., dessert), options associated with the cooking process, and background information, to view details about a specific ingredient in the recipe, to view a list of tools needed for the recipe, to tag the recipe for later, to start cooking, or to start a to-do list associated with the recipe.

FIG. 6 is an example guided assistance graphical user interface (GUI) 600 that presents a user a particular cooking process for a selected recipe, according to various embodiments. In the illustrated embodiment, the guided assistance GUI 600 presents integrated culinary content associated with making the recipe, including meal preparation time, tools needed for the cooking process, techniques, ingredients, and instructions in an organized, sequential format (e.g., prior step, current step, subsequent step, etc.). The guided assistance GUI 600 can present the integrated culinary content using various media that are in sync with one another. For example, the guided assistance GUI 600 presents a video of a chef that gives instructions in sync with the flow of the cooking instructions. In some embodiments, the user can control the flow of the cooking instructions. For example, the user can stop, start, go into details, go backwards, or go forward in the content of the cooking process to review a particular step more carefully. In such example, the guided assistance GUI 600 can adjust the video to play in accordance with the user's selection to stop, start, go backwards, forwards, etc. In some embodiments, the instructor associated with the recipe (e.g., chef) can be in a videoconference with the user to instruct the user at each step.

FIG. 7 is an example videoconference graphical user interface (GUI) 700 that allows the user to communicate with another individual while cooking, according to various embodiments. In the illustrative embodiment, a user can select one or more individuals to start cooking using the content delivery platform 110 of FIG. 1. The one or more individuals can be, for example, a family member, a friend, a personal chef, or a remote cooking class. If the consumer selects to cook by himself, he can proceed to select a recipe right away.

If the consumer selects to cook with one or more individuals, the platform initiates a videoconference with the one or more individuals. The platform device can request contact information of those individuals from the consumer. In some instances, the platform device prompts the consumer to submit an identifier associated with the one or more individuals. The identifier can be, for example, a username, an email address, a telephone number, or an IP address. In some instances, the platform device prompts the consumer to select individuals from an address book stored on the platform device. The address book can be a personal address book of the consumer, or it can be a global address book of a service server associated with the platform device (e.g., names of all consumers of the platform device).

FIGS. 8-9 illustrate example alert graphical user interfaces (GUI) 800, 900 that can be generated during a cooking session, according to various embodiments. In various embodiments, the content delivery system 110 of FIG. 1 can generate the alert associated with the content. In the illustrated example of FIG. 8, the platform generates a pop-up alert to notify the consumer that the pot has been boiling for 20 minutes, where the step instructs only 15 minutes. In some embodiments, the platform can generate alerts associated with allergens by analyzing data in its databases and/or third-party databases. In some embodiments, the platform can infer certain information about a user by analyzing data from past cooking sessions. For example, the user has submitted information during a past cooking session that she does has a peanut allergy, which has not been recorded in the user's profile. In such example, the platform generates a food alert when the user selects a recipe that involves peanuts, as illustrated in FIG. 9.

FIG. 10 is an example user profile graphical user interface (GUI) 1000 that allows a user to customize the profile, according to various embodiments. In the illustrated embodiment, the user is able to submit full name, nickname, birthday, preferred language, ethnicity, address, and a password. The user can also customize the theme, mode, color, diet, allergies, history, budget, and flavor associated with the user's food and/or cooking preferences. In some embodiments, such data submitted by the user is stored for future analysis. For example, the content delivery platform analyzes the data to determine recipes that fit the user's preferences. In another example, the data is analyzed to generate alerts (e.g., allergies).

FIG. 11 is an example health tracker graphical user interface (GUI) 1100 that allows a user to track health associated with the user's cooking history, according to various embodiments. In some embodiments, the system analyzes the ingredients from the recipe and presents nutritional information in the health tracker GUI 110. The health tracker includes a visual food diary of meals completed by the consumer. The visual food diary can include, for example, types of foods and/or ingredients associated with those meals. In various embodiments, the health tracker utilizes nutritional guidelines data from various sources (e.g., guidelines published by the USDA or internal stored data) and combines such data with data associated with a specific recipe (e.g., meal preparation, ingredients, etc.). The health tracker compares the combined data is to caloric output data of the user. The caloric output data can be obtained from manual user submission of information (e.g., user inputs of calories from workouts) or from automatic data transmission associated with one or more electronic devices such as wearable electronic devices (e.g., Pebble®). In some embodiments, the health tracker includes a net calorie calculator to assist the user in tracking health in association with the recipes prepared.

FIG. 12 is an example food diary graphical user interface (GUI) 1200 that allows a user to keep a history of the user's food, according to various embodiments. In various embodiments, the food diary works in coordination with, or is a part of, the health tracker discussed in FIG. 11. The food diary presents information extracted from meals (or recipes) prepared by the user. The information extracted include analysis of the nutritional values associated with the meals, including, for example, the types of ingredients involved and the amount of nutrients of each type.

FIG. 13 is a sequence diagram illustrating a process 1300 for providing culinary content based on user inputs using a content delivery device, according to various embodiments. Note that the following description of FIG. 13 will be described using the embodiment and components of the illustration of FIG. 1, and will refer to labels of FIG. 1. Note further that the process 1300 is a non-limiting example, and is illustrated in conjunction with FIG. 1 with the intent of making the description of FIG. 13 easier to understand. The process 1300 illustrates three different sub-processes, a recipe request 1350, recipe selection 1360, and a user feedback 13070, where in the three sub-processes, the content delivery device dynamically changes various content being provided to a user 102 based on user inputs, where the various content is adapted to the user's progress (and/or understanding) of a cooking process.

Referring to the recipe request 1350 sub-process, the user 102 accesses the content delivery device 104 to start cooking. The content delivery device 104 provides, in real-time, a guided assistance containing culinary content that dynamically changes in real-time based on inputs from the user 102. The guided assistance can be in the form of an application (“app”) that runs on the device 104. For example, the application can be a native app that is installed on an electronic device (of the user 102) by a device manufacturer or operating system manufacturer. In another example, the application can be a mobile application that is downloaded by the user 102 on his mobile device from an application store (e.g., GooglePlay®) or directly from an application publisher. In yet another example, the application is an application operating via a cloud service. The content delivery device 104 can include various input and output (I/O) devices that enable the device to receive inputs from the user and to output content responsive to the inputs. The I/O devices can include a touch-screen display, a microphone, a keyboard, etc.

At step 1302, the user 102 submits one or more recipe criteria to request a recipe from the content delivery device 104. For example, the recipe criteria can be one or more ingredients the user has in his refrigerator and desires to prepare a meal with those ingredients. In another example, the recipe criteria can be a cuisine preference (e.g., Italian), a diet preference (vegetarian), etc. In some embodiments, the user 102 can submit the recipe criteria using a tuning interface presented on a display of the content delivery device 104. With every new criterion the user submits via the tuning interface, the content delivery device 104 outputs culinary content in the form of one or more recipes fitting that criterion. For example, the device 104 outputs several spaghetti meatball dishes when user 102 first submits mushrooms and tomatoes as the ingredients, but dynamically changes (e.g., filter) the content to display only vegetarian spaghetti dishes when the user 102 next submits vegetarian.

The content delivery device 104 communicates with a content delivery system 110 in order to provide the culinary content that adapts to inputs of the user 102, as indicated in step 1304. The content delivery system 110 can be a computer system utilized by a content culinary service organization that distributes active guided assistance to users for improving their cooking experiences. As used here, the term “active” refers to information being dynamically updated to provide, to a user, assistance at every step of a cooking process. At step 1306, the content delivery system 110 searches within its database for data that correspond to the user inputs received at step 1302. In particular, the content delivery system 110 analyzes the user inputs to identify relational references with various culinary data in the database. For example, the system 110 identifies a user profile associated with the user 102 to determine, for example, food allergies, taste preferences, past meals prepared using recipes of the system 110, health goals, and searches the database for one or more recipes that correspond to the user profile and the submitted criteria. In some embodiments, the content delivery system 110 can also communicate with one or more third-party systems 122 to access content that correspond to the submitted criteria, as indicated in steps 1308a, 1308b. For example, the content delivery system 110 can communicate with a publisher of a website that provides recipes on vegetarian dishes.

In response to the data obtained (e.g., step 1306 and/or 1308a, 1308b), the content delivery system 110 analyzes and organizes the data as integrated culinary content (e.g., recipes for the sub-process 1350), and sends the content to the content delivery device 104 back to the user 102. At step 1310, the content delivery system 110 outputs the integrated culinary content on the display for the user 102. For example, the device presents a list of low-fat, no-peanut, vegetarian recipes to the user based on the user profile and the submitted criteria. The user 102 can submit additional recipe criteria, and the content would change dynamically based on the additional criteria. In such scenario, steps 1302-1310 are repeated until the user 102 is satisfied with the recipes presented.

Referring to the user feedback sub-process 1360, the user 102 selects a recipe from the one or more recipes provided on the display of the content delivery device 104 at step 1312. The content delivery device 104, in response to the recipe selection, provides culinary content for the user 102. The culinary content can include integrated information obtained from various data sources, such as a content delivery database or one or more third-party systems. The content delivery device 104 provides the integrated culinary content through the steps 1314-1320. The integrated culinary content can include preparation, or cooking, steps of the selected recipe, timing indicators associated with the steps (e.g., boil the water for 5 minutes) of the recipe, techniques associated with the steps of the recipe (e.g., how to peel a potato, how to flip a pancake, etc.), cooking tools, or cookware, associated with the steps of the recipe, and ingredients for the recipe (and the steps).

In the user feedback sub-process 1370, the user 102 can provide various user feedback by submitting inputs to the device 104 (e.g., step 1322). Such inputs indicate the user's cooking progress in real-time, such that the device 104, working in coordination with the system 110 (and/or the third-party systems 122) (e.g., steps 1324-1328), can dynamically update the integrated culinary content presented on the display for the user (e.g., step 1330).

Consider an example scenario where the user selects a recipe to make a poached egg salad. The content delivery device 104 communicates with the content delivery system 110 and/or the third-party system(s) 122 to obtain data on the timing, techniques, tools, ingredients, and actions (i.e., cooking steps including, for example, preparing ingredients, actual cooking of the meal, and finalizing the cooking (e.g., cooling)) associated with the poached egg salad recipe. In response to receiving back the data, the content delivery device 104 outputs such data on the display for the user 102. The outputting of the data, or “presentation” of information, can be in a mixed-media format. The mixed-media can include, for example, a powerpoint presentation, an image (e.g., picture of an egg), a video, or an audio. The mixed-media format enhances the user's understanding of the cooking process better than the traditional flat presentation of cooking steps.

In the scenario, the content delivery device 104 sequentially presents the cooking steps to the user 102. The cooking steps can include, for example, one or more preparation steps (e.g., scrub the potatoes under warm water), one or more execution steps (e.g., cook in oven at 475 degrees for 20 minutes), and one or more finalizing steps (e.g., let the casserole cool for 10 minutes). The user 102 can select a particular step (from the sequence of steps) to indicate to the device 104 that he is currently cooking that step in real-life. Upon selection of a particular step, the device 104 presents to the user 102 (e.g., at step 1320) one or more timing indicators, one or more techniques, one or more ingredients, and one or more tools for the particular step. For example, the device 104 displays a video footage of water boiling to assist the user in understanding what boiling water should look like, and three images of a pot, a vinegar bottle, and water to indicate the tool and ingredients needed.

For example, the user 102 can touch (e.g., touch input) each of the three images on the display to check off an item needed for the step, where such touch input provides an indication that the user 102 has completed the sub-steps needed in the current cooking step. The device 104, working along with the system 110 (and/or third-party systems 122), can dynamically update the presentation of information on the display with subsequent sub-steps or next steps after receiving each touch input.

For example, the presentation is updated with a pop-up message that asks the user 102 whether the water is boiling. When the user selects “Yes” (e.g., at step 1322), the presentation provides another pop-up message (e.g., 1330) asking whether the user has the egg(s) ready. When the user selects “No,” the device 104, working in coordination with the system 110, presents a new subsequent step. For example, instead of the next step instructing the user 102 to crack the egg into the pot of water, the device 104 displays the next step instructing the user 102 to lower the heat. In another example, the user 102 indicates, via a user submission, that he does not know how to place the egg in the pot for the poaching process.

The device 104 can display content associated with the technique to place the egg in the pot responsive to such feedback. The content can be a pop-up video or a digital animation that demonstrates cracking the egg in a long wooden spoon and slowly placing it in the pot. The device 104, in coordination with the system 110 (and/or third-party systems 122) can dynamically change any of the timing indicators, the techniques, the tools, the ingredients, and the steps to correspond to each user feedback submission (e.g., at step 1322) at every current step being performed by the user 102 in real-life. For example, while displaying the technique video to the user 102, the remaining content (e.g., timing, tools, ingredients, and steps) is updated to correspond to the user watching the technique. For example, the timing indicators for the subsequent steps are readjusted and the tool(s) needed for the current step is updated (e.g., wooden spoon image appears). Hence, the user 102 benefits from an active, real-time assistance that provides content enhancing the user's cooking experience.

FIG. 14 is a flow diagram of a process for generating integrated culinary content for cooking in real time based on user input, culinary data, and advertising data, according to various embodiments. In various embodiments, the process 1400 may be executed in a system such as system 200 of FIG. 2. At step 1402, the system receives inputs from a user requesting to search for a recipe to start a cooking process. The user inputs can include, for example, a list of ingredients the user wants to search for a recipe, a taste preference, an ethnic food category, a total cook time, among others. In some embodiments, the system allows the user to submit the inputs using a recipe tuning interface, where the system can dynamically generate content in response to each input (of many inputs) received from the user. For example, in response to “smoked tofu” and “kale”, the system generates ten recipes with those ingredients. When the user submits a “30 min total cook time” input, the system filters the ten recipes in real-time to include only recipes that require 30 minutes or less of total cook time.

At step 1404, the system generates the recipes based on the user inputs submitted in step 1402 on a user interface of a display to allow the user to select a recipe. At step 1406, the system generates culinary content associated with the selected recipe. The culinary content includes integrated information from various sources, such as an encyclopedia of foods, a cookbook, and/or a diet meal program. In some embodiments, similar to the recipes generated in step 1404, the culinary content can be dynamically changed based on user inputs, as indicated in step 1408. For example, the user interacts with the display to go into details about a mushroom ingredient of the recipe, and in response, the system retrieves information associated with other varieties of mushroom that can be used in the recipe. In another example, the user can select the tools, or cookware, needed for the recipe, and the system can generate a list of products available from various retailers that correspond to the tools, and redirect the user to another interface that enables the user to purchase one or more products.

FIG. 15 is a block diagram of a computer system as may be used to implement features of some embodiments of the disclosed technology. The computing system 1500 may include one or more central processing units (“processors”) 1505, memory 1510, input/output devices 1525 (e.g., keyboard and pointing devices, display devices), storage devices 1520 (e.g., disk drives), and network adapters Error! Reference source not found. 1530 (e.g., network interfaces) that are connected to an interconnect 1515. The interconnect 1515 is illustrated as an abstraction that represents any one or more separate physical buses, point to point connections, or both connected by appropriate bridges, adapters, or controllers. The interconnect 1515, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 1510 and storage devices 1520 are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media can include computer-readable storage media (e.g., “non-transitory” media) and computer-readable transmission media.

The instructions stored in memory 1510 can be implemented as software and/or firmware to program the processor(s) 1505 to carry out actions described above. In some embodiments, such software or firmware may be initially provided to the processing system by downloading it from a remote system through the computing system 1500 (e.g., via network adapter 1530).

The technology introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the invention. Accordingly, the invention is not limited except as by the appended claims.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Those skilled in the art will appreciate that the logic illustrated in each of the flow diagrams discussed above, may be altered in various ways. For example, the order of the logic may be rearranged, substeps may be performed in parallel, illustrated logic may be omitted; other logic may be included, etc.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

1. A method, comprising:
receiving from a user a request for a recipe, the request including a plurality of recipe criteria;
retrieving, from a data storage, a plurality of recipes based on the plurality of recipe criteria;
displaying the plurality of recipes to the user on a display for selection by the user;
generating, in response to receiving a user selection of a recipe from the plurality of recipes, a presentation associated with the recipe on the display for the user, the presentation including (a) a plurality of sequential cooking steps corresponding to the selected recipe and (b) cooking data corresponding to the plurality of sequential cooking steps, the cooking data comprising a plurality of cooking techniques, a plurality of cooking tools, a plurality of ingredients, and a plurality of timing indicators; and
monitoring a current cooking step of the plurality of sequential cooking steps, the monitoring comprising:
detecting a user submission associated with the current cooking step presented in the presentation on the display, the user submission indicative of a user progress associated with the current cooking step; and
generating an updated presentation associated with the recipe in response to the user submission, wherein generating the updated presentation includes dynamically altering any of a subsequent cooking step, a cooking technique, a cooking tool, an ingredient, or a timing indicator presented in the presentation.

2. The method of claim 1, wherein the presentation comprises mixed media content, wherein the plurality of sequential cooking step is presented using a mixed media format.

3. The method of claim 1, wherein the presentation comprises mixed media content, wherein the cooking data is presented using a mixed media format.

4. The method of claim 1, wherein the presentation comprises advertising data that correspond to (a) the plurality of sequential cooking steps and (b) the cooking data.

5. The method of claim 1, wherein the user submission comprises at least one of:
a voice command, a keyboard input, or a touch-display input.

6. A method, comprising:
outputting on a display, in response to a user selection of a recipe from a plurality of recipes, a plurality of sequential cooking steps associated with the recipe and cooking data corresponding to the plurality of sequential cooking steps;
receiving a user submission associated with a current cooking step of the plurality of sequential cooking steps, the user submission indicative of a user progress associated with the current cooking step; and
modifying, in response to the user submission indicative of the user progress, the plurality of sequential cooking steps and the cooking data on the display.

7. The method of claim 6, wherein the cooking data comprises a plurality of cooking techniques, a plurality of cooking tools, a plurality of ingredients, and a plurality of timing indicators associated with the recipe.

8. The method of claim 6, wherein modifying the plurality of sequential cooking steps and the cooking data being displayed comprises:
dynamically altering any of a subsequent cooking step, a cooking technique, a cooking tool, an ingredient, or a timing indicator associated with the recipe.

9. The method of claim 6, wherein displaying the plurality of sequential cooking steps and the cooking data comprises utilizing a mixed media format for the displaying.

10. The method of claim 6, wherein the mixed media format comprises at least one of: a video format, an audio format, a still-image format, a word document format, or a powerpoint presentation format.

11. The method of claim 6, wherein the user submission comprises at least one of:
a voice command, a keyboard input, or a touch-display input.

12. The method of claim 6, further comprising:
outputting on the display advertising data that corresponds to (a) the plurality of sequential cooking steps and (b) the cooking data.

13. The method of claim 6, further comprising:
outputting on the display a health report in response to a user health request, the health report including nutritional data associated with the recipe selected.

14. The method of claim 6, further comprising:
outputting on the display a videoconference session associated with the recipe selected in response to a user videoconference request.

15. A kitchen apparatus, comprising:
a recipe storage component configured to store data associated with a plurality of recipes;
a data gathering component configured to receive user input data, the user input data including user criteria data and user progress data;
an analysis component configured to generate integrated culinary content that corresponds to the user input data, the integrated culinary content generated by cross-analyzing the user input data with the data associated with the plurality of recipes;
a recipe component configured to organize a plurality of recipes based on the integrated culinary content;
a guidance component configured to display the plurality of recipes and the integrate culinary content to a user, wherein the guidance component is further configured to dynamically alter the plurality of recipes and the integrated culinary content in response to new user input data.

16. The kitchen apparatus of claim 15, wherein the integrated culinary content comprises a plurality of sequential cooking steps, a plurality of cooking techniques, a plurality of cooking tools, a plurality of ingredients, and a plurality of timing indicators.

17. The kitchen apparatus of claim 16, wherein the integrated culinary content further comprises advertising data.

18. The kitchen apparatus of claim 16, wherein the integrated culinary content further comprises advertising data associated with the plurality of sequential cooking steps, the plurality of cooking techniques, the plurality of cooking tools, the plurality of ingredients, and the plurality of timing indicators.

19. The kitchen apparatus of claim 15, wherein the user input data comprises at least one of: a voice command, a keyboard input, or a touch-display input.

20. The kitchen apparatus of claim 15, wherein the guidance component is further configured to display a health report in response to a user health request, the health report including nutritional data associated with the recipe selected.
